(19) United States
(12) Patent Application Publication
(10) Pub. No.: US 2004/0087761 A1
(43) Pub. Date: May 6, 2004

(54) Novel polycarbazole and process for preparation thereof

(76) Inventors: Michiya Fujiki, Ikoma-shi (JP); Charles E. Mckenna, Pacific Palisades, CA (US); Zhong-Biao Zhang, Alhambra, CA (US)

Correspondence Address: WENDEROTH, LIND & PONACK, L.L.P., 2033 K STREET N. W., SUITE 800, WASHINGTON, DC, 20006-1021, US

(21) Appl. No.: 10/285,473

(22) Filed: Nov. 1, 2002

(51) Int. Cl. C08G 61/12

(52) U.S. Cl. 528/423

(57) ABSTRACT

The present invention involves a novel polycarbazole, more specifically, a polycarbazole, of which repeating unit is a formula

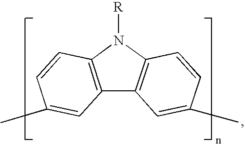

wherein R is an optically active hydrocarbon group increasing solubility of the compound to solvent and n is from 5 to 100000,

a process for preparation thereof, and a thin solid film comprising the polycarbazole, and a process for preparation thereof.

### FIELD OF THE INVENTION

The present invention involves novel polycarbazoles, a process for preparation thereof, and thin solid films comprising the polycarbazoles, and a process for preparation thereof.

### BACKGROUND OF THE INVENTION

The prior literature relating to the present invention exists: Zhong-Biao Zhang, Michiya Fujiki, Hong-Zhi Tang, Masao Motonaga, and Keiich Torimitsu, “The First High Molecular Weight Poly(N-alkyl-3,6-carbazole)s”Macromolecules, Vol.35, pp 1988-1990(2002)).

In 21^{st} century's information technology, it is highly expected to use convenient, fast, cheap, light and tiny storage media to record tremendous amount of digital information. In the field of home electronics, it is expected that digital information recording devices such as Digital video, DVD-RAM and hard disk magnetic storage will rapidly develop hereafter for full-scaled digital broadcasting business. MO mode utilizes slight change of optical Kerr rotation angle (change of angle of optical activity) before and after magneto-optical “writing”. To accomplish a good contrast/noise ratio, it is needed to provide a reflection mirror on the back of a medium, and to utilize the change of the Kerr rotation angle which is magnified up to 0.3° before and after magneto-optical writing.

To detect the 0.3° of slight change of Kerr rotation angle, MO needs a finer and larger detecting mechanism as compared with the other magnetic recording. The reading and writing speed of MO is about 30 milliseconds, one reason why the speed is 3 to 5 times slower than that of the magnetic recording can be understood that as for MO the detection head containing a beam splitter is big and heavy, so the speed of servo track is also slow. Moreover, both laser head and magnetic head are necessary, which leads to limitation for miniaturization of the Whole instrument. If a photo-readable, photo-writable and photo-erasable film material having the change of much more than 0.3° of rotation angle can be found, an all-photo-recording technique utilizing the optical-activity will be accessed, in addition, miniaturization of the recording instrument, and high speed writing and reading comparable to hard disk will be allowed.

On the other hand, photo-recording materials such as magneto-optical recording (MO) on inorganic magnetic films or phase drift recording (PD) on inorganic films are presently known, and storage devices based on this principle are commercially available. Photo-readable storage density is increased inversely proportional to the square of laser wavelength. Therefore, use of for example, GaN laser element called as a light source in the next generation, invented by Nichia Corporation, Tokushima Japan, of which emission band is 370-430 nm in UV-region, may allow a recording medium with the density of several times higher than that of the current DVD-RAM(laser wavelengths: 635 and 650 nm). In addition, recording as much as several ten times higher density than the current DVD-RAM(laser wavelength: 635 and 650 nm) will be allowed, if a material corresponding to shorter wavelength lasers (for example, 185-215 nm, double wave of the GaN laser) can be put into practice in the future.

Recently, n-conjugated polymers have received considerable interest as opto-electronically functional materials, and a lot of researches directed to applications such as asymmetrc sensing and separation matarials, polymer semiconductors and condutors, electrochromic and electroluminescent, and nonlinerar optical materials have been reported. A known process in order to obtain polycarbazoles having the above properties is polymerization by debromination of a 9-substituted poly-3,6-dibromocarbazole using a catalyst. All the polycarbazoles obtained by the reported processes have poor film-forming ability due to the low molecular weight (2000-3000), which is unadequate for real application.

Recently, we reported the successful synthesis of polycarbazoles with good film-forming ability, of which weight average molecular weights are about 90000-100000, wherein the polycarbazole has n-decyl group at 9-position or 3,7-dimethyloctyl group at 9-position. However, since n-decyl group does not have optical activity, the polycarbazoles resulted from the introduction of it. In addition, although 3,7-dimethyloctyl group is an optically active substituent, the obtained polycarbazoles so far are optically inactive in solution, aggregation, and thin solid film state, because these polycarbazoles are resulted from the introduction of certain 3,7-dimethyloctyl group with poor optical purity. (Zhong-Biao Zhang, Michya Fujiki, Hong-Zhi Tang, Masao Motonaga, and Keiich Torimitsu, “The First High Molecular Weight Poly(N-alkyl-3,6-carbazole)s”Macromolecules, Vol.35, pp 1988-1990(2002)).

It is reported recently that a n-conjugated polymer bearing an optically active chiral alkyl substituent at the 9-position, namely poly(3,7-dialkylfluorene), can form cholesteric liquid crystals, which shows large anisotropy factor in cicular dichroism absoption, circularly polarized photoluminescence and/or electroluminescence.(M. Oda, H.-G. Nothofer, G. Lieser, U. Scherf, S. C. J. Meskers; and D. Neher, Advanced Materials, Vol. 12, pp. 362-365 (2000)). If a high molecular material exhibiting circular dichroism absorption, circularly polarized photoluminescence and/or electroluminescence, can be provided cheaply and conviniently, It is expected applications to a thin solid film recording medium or a cicular dichroism generating element on a solid disk such as a plastic plate or a glass plate following to the method such as spin coating, and formation of an industrially new market will be expected.

On the other hand, n-conjugated polymers, polycalbazoles have better cooperation with ITO or Au electrodes as compared with plyfluorenes. Therefore, use of polycarbazoles will permit to construct opto-electronically functional devices and asymmetric recognition devices with better performance. However, the conventional polycarbazoles have severe problems in the properties such as electric conductivity, controllability of conductivity carrier concentration, controllability of mobility, and asymmetric recognition ability, as well as convenience in the process of preparation for a thin solid film, in addition to the low molecular weight.

### SUMMARY OF THE INVENTION

The first objective of the present invention is to provide novel optically active polycarbazoles exhibiting effective and remarkable circular dichroism absorption signal in UV-region, and a process for preparation thereof. These novel polycarbazoles may allow construction of opto-electronically functional devices with high performance utilizing optically active polymers, of which circular dichroism absorption and cicularly polarized photoluminescence, and electroluminescence largely changes by the emission band at violet blue to near-UV region, corresponding to 380-430 nm lasers, generated by for example, GaN laser element which Nichia Corporation, Tokushima, Japan produces and provides.

The second objective of the present invention is to provide thin solid films made of the above novel polycarbazoles, used for the above opto-electronically functional devices with high performance, having solubility to solvent, and having enough mechanical strength, as well as a process for preparation thereof.

The inventors now have produced novel polycarbazoles exhibiting significant circular dichroism absorption by introduction of a certain alkyl substituent with high optical purity. Surprisingly, such compounds exhibit larger circular dichroism than sum of the circular dichroism based on the chirality of the side chain and that based on the helicity of the principal chain.

The present invention thus provides a polycarbazole, of which repeating unit is a formula

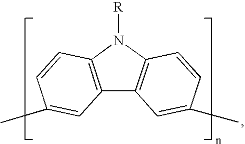

wherein R is an optically active hydrocarbon group, and n is from 5 to 100000.

R may be an optically active hydrocarbon group having not less than 4 carbon atoms, particularly not less than 5 carbon atoms, and not more than 100 carbon atoms.

R increasing solubility of the compound in an organic solvent is preferable.

R may preferably be selected from a group consisted of (S)-2-methylbutyl, (R)-2-methylbutyl, (S)-3-methylpentyl, (R)-3-methylpentyl, (S)-3,7-dimethyloctyl, (R)-3,7-dimethyloctyl, (S)-2-methyloctyl, (R)-2-methyloctyl, (S)-citronellyl and (R)-citronellyl.

R may especially preferably be selected a group consisted of (S)-2-methylbutyl, (R)-2-methylbutyl, (S)-3-methylpentyl, (R)-3-methylpentyl, (S)-3,7-dimethyloctyl, (R)-3,7-dimethyloctyl, (S)-citronellyl, and (R)-citronellyl.

In particular, R relatively readily available by the commercial production may be selected a group of (S)-2-methylbutyl, (S)-3-methylpentyl, (S)-citronellyl, (R)-citronellyl, (S)-3,7-dimethyloctyl and (R)-3,7-dimethyloctyl.

n may preferably be selected from 5 to 100000, more preferably from 10 to 50000, still more preferably from 20 to 50000 and most preferably from 25 to 50000.

(Process for Preparation of the Compound)

The present invention provides a process for preparation of the above compound. The process comprises: providing a starting material; introducing the above R substituent into the 9 position; and poly-condensating the resultant R-substituted monomer in the presence of the following poly-condesation catalyst; then the polymer compound of interest may be obtained.

(Preparation of Starting Material)

In said process, 3,6-dibromocarbazole, for example is obtainable according to a known procedure.

Alternatively, instead of the 3,6-dibromocarbazole, any halogenated carbazole may also be used. The other preferable starting material is 3,6-diiodocarbazole.

(Introduction of R Substituent into 9 Position)

The above optically active hydrocarbon group R, of which number of carbon atoms is not less than 4, particularly not less than 5, may be introduced into the 9 position of the above 3,6-dihalogenated carbazole such as 3,6-dibromocarbazole or 3,6-diiodocarbazole according to a known procedure.

(Polymerization Catalyst)

In the present invention, various poly-condensating (polymerization) catalysts (such as a highly active zerovalent zinc (Rieke catalyst), organic magnesium, metal magnesium, highly active zerovalent nickel) can be used. See: (1) Takakazu Yamamoto, “n-Conjugated Polymers Bearing electronic and Optical Functionalities. Preparation by Organometallic Polycondensations, properties, and Their Applications”, Bull. Chem. Soc. Jpn., Vol. 72, 621-638(1999); (2) Takakazu Yamamoto, “n-conjugated Plymers with Electronic and Optical Functionalities. Preparation by Organometallic Polycondensation, Properties, and Applications” Macromolecular Rapid Commun. Vol. 23, 583-606(2002).

In the case of the zerovalent nickel, the ligand such as cyclooctadiene (COD) or triphenylphosphine can be utilized, and the polymerization reaction rapidly be proceeded.

According to the process of the present invention, there is provided a polycondensating catalyst obtainable by mixing materials comprising zerovalent nickel, cycrooctadiene, triphenylphosphine, and/or bipyridyl. A preferable polymerization catalyst is obtainable by mixing materials comprising Ni(COD)₂, cycrooctadiene, triphenylphosphine and/or bipyridyl, but is not limited to it.

The present invention provides a poly-condensating catalyst obtainable by mixing materials comprising zerovalent nickel, cycrooctadiene, triphenylphosphine and/or bipyridyl. The present invention provides a polycondensating catalyst obtainable by mixing materials comprising Ni(COD)₂, cycrooctadiene, triphenylphosphine and/or bipyridyl.

The present invention provides the above polymerization catalyst to polymerize the above R-substituted 3,6-dihalogenated carbazole. Each of the materials for the catalyst may be mixed in any ratio or order.

Also, the above R-subsutituted 3,6-dihalogenated carbazoles may be used in the solution form in solvent. The solvent may be any anhydrous solvent (high permittivity solvent such as DMF, DMSO or dimethylacetoamide), or combined solvent with toluene including them, and the preferable one is but not limited to DMF. In short, any solvent, in which the dihalogenated carbazoles and the resultant carbazoles can be dissolved, is possible and nonlimiting.

The concentration of the 3,6-dihalogenated carbazole to be dissolved in the solvent may be from 0.1% to 50% by weight, and preferably from 5% to 25% by weight.

Preferably, Ni(COD)₂, cycrooctadiene and bipyridyl in solvent may be added to the solution of the R-substituted 3,6-dihalogenated carbazoles gradually. Any solvent in which the above 3,6-dihalogenated carbazoles can be dissolved may be, used. The solvent may be any anhydrous solvent (high permittivity soluvent such as DMF, DMSO or dimethylacetoamide), or combined solvent with toluene including them. In short, any solvent, in which the dihalogenated carbazoles and the resultant carbazoles can be dissolved, is possible and nonlimiting.

The above reaction temperature may preferably be from 30 to 100° C., more preferably from 35 to 90° C., and still more preferably from 50 to 70° C.

(Thin Solid Film)

The resultant crude product may optionally be purified according to a known procedure.

Additionally, the present invention provides a thin solid film comprising the above novel polycarbazole(s). In the present specification, the above “thin solid film” refers to a film of 10 nm to 5000 nm thickness.

The solid film according to the present invention is characterized by having function causing change of the direction of the chirality and/or large change of the signal intensity, and being smooth, scattaring-less and transparent. The polycarbazoles according to the present invention may be prepared in any molecular weight, and have better film-forming ability than the polycarbazoles having the same level of molecular weight and described in the references such as Macromolecules, Vol. 35, pp.1988-1990(2002))

A film of opto-electronical recording material is generally formed following to vapor-deposition etc. The above thin solid film is characterized by the capability of being formed following to spin coating, dipping, or solvent casting at normal pressure and temperature.

(Process for Preparation of Thin Solid Film)

In addition, the present invention provides a process for preparation of the above thin solid film comprising dissolving the above novel polycarbaole(s) in good solvent, and mixing the resultant solution and poor solvent.

The above good solvent is any solvent the novel polycarbazole can be dissolved, and the solvent may be for example but not limited to tetrahydrofuran or DMF.

The above poor solvent may be any solvent of which solubility is much lower than that of the above good solvent. Preferably, the poor solvent may be but not limeted to alchols such as methanol, ethanol, isopropanol or 1-octanol.

The process for preparation of the thin solid film is characterized by the capability of obtaining a smooth, scattering-less and transparent thin solid film, having function of causing change of the direction of the chirality and/or large change of the signal intensiy.

The process for preparation of the thin solid film is characterized in that the thin solid film can be formed by spin coating, dipping or the solvent casting at normal pressure and temperature.

(Effect of Invention)

According to the processes disclosed by the present invention, optically active polycarbazole compounds exhibiting significant circular dischroism absoption at near UV-region can be obtained with high yield and good reproducibility. A significant effect capable of constructing opto-electronic devices with high performance using the novel optically active compounds, and for example, GaN laser light source of 380-430 nm manufactured by Nichia Corporation is provided.

### BRIEF DESCRIPTION OF THE DRAWINGS

FIG. 1 shows ultraviolet-visible (UV-vis) absorption and circular dichroism dispersion spectra of poly(9-(S)-3,7-dimethyloctylcarbazole) and poly(9-(R)-3,7-dimethyloctylcarbazole)(tetrahydrofuran, 20° C.).

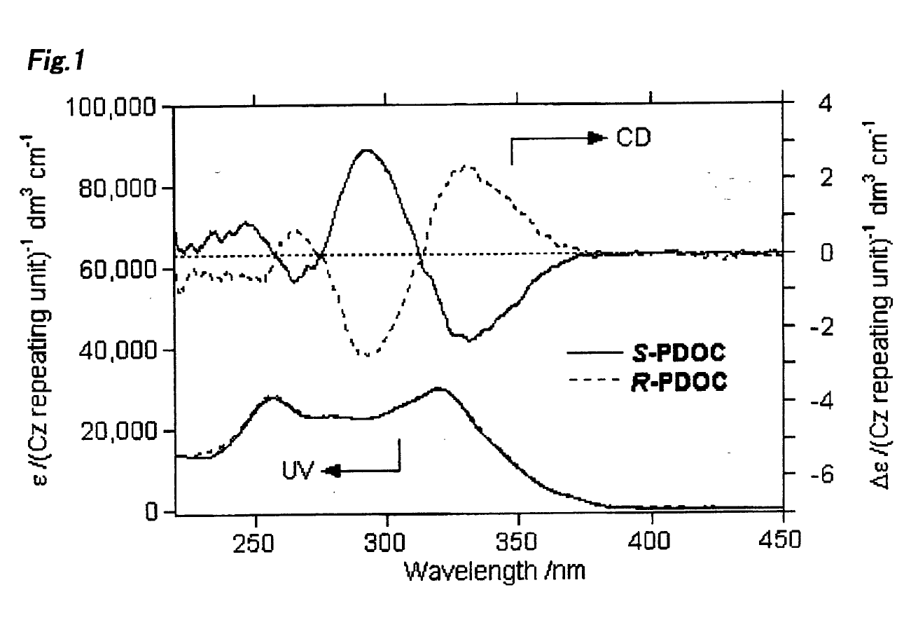

FIG. 2 shows dependence of degree of polymerization of poly(9-(S)-3,7-dimethyloctylcarbazole) and poly(9-(R)-3,7-dimethyloctylcarbazole)(tetrahydrofuran, 20° C.).

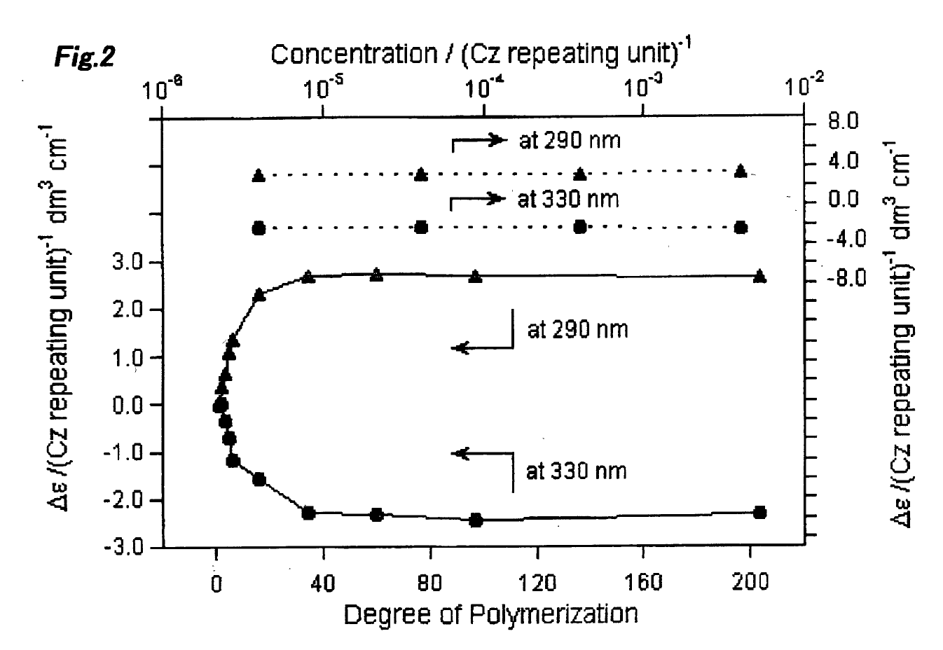

FIG. 3 shows relationship between UV-vis absorption or circular dichroism dispersion spectra intensity change and concentration of 1-octanol of poly(9-(S)-3,7-dimethyloctylcarbazole) aggregate (tetrahydrofuran as good solvent and 1-octanol as poor solvent are used, 20° C.).

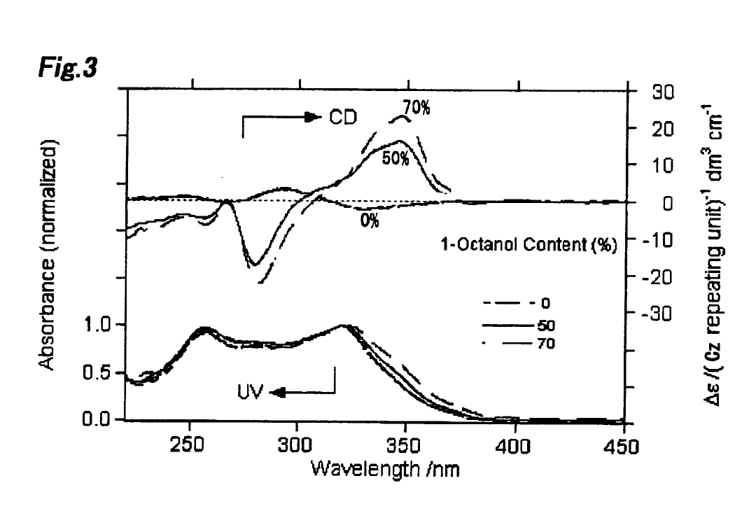

FIG. 4 shows relationship between UV-vis absorption or circular dichroism dispersion spectra intensity change of poly(9-(R)-3,7-dimethyloctylcarbazole) aggregete (tetrahydrofuran as good solvent and 1-octanol as poor solvent are used, 20° C.).

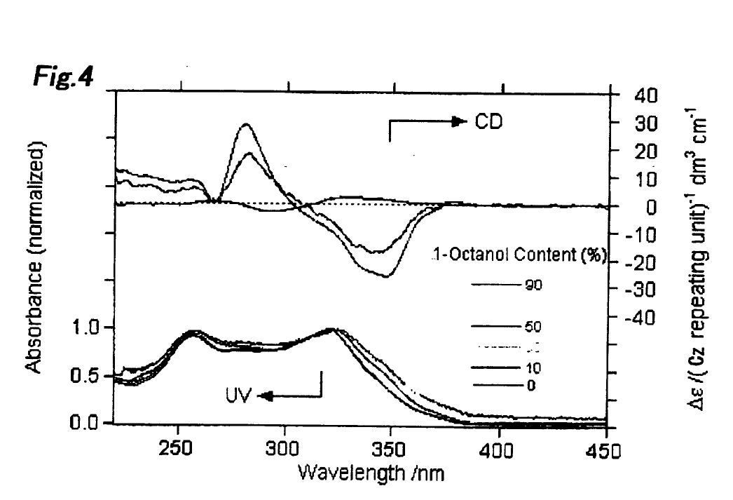

### DETAILED DESCRIPTION OF THE PREFERRED EMBODIMENTS

The examples as bellow shall illustrate the present invention but not limit the scope of the invention.

### EXAMPLE 1

### Materials

Chemical reagents such as bis(1,5-cyclooctadiene) Ni (0) (Ni(COD)₂), 1,5-cyclooctadiene (COD), and I,1′-bipyridyl (Bpy) were purchased from Kanto, and 3,6-dibromocarbazole from Aldrich. (S)-and (R)-3,7-dimethyloctyl bromides were synthesized by Chemical Soft, Kyoto, Japan. Solvents such as anhydrous DMF, THF, 1-octanol, isopropanol, ethanol, and methanol were purchased from Kanto. They were all used as received.

### EXAMPLE 2

### Measurements

Molecular weights were estimated by size exclusion chromatography (SEC) on a Shodex KF806M column (eluent THE, 30° C.) using a Shimadzu liquid chromatography instrument equipped with a photodiode array detector based on the calibration of polystyrene standards. CD and simultaneous Uv-vis spectra were recorded using a JASCO J-725 spectropolarimeter at 20° C. (I cm path length cell; sample concentration=4×10⁻⁵ mol/L of the carbazole repeating units. For concentration dependent measurements, 0.01, 0.1, 1, 10 cm path length cells were used for sample concentration of 4×10⁻³, 4×10⁻⁴, 4×10⁻⁵, 4×10⁻⁶ mol/L, respectively.). NMR spectra were recorded on a Varian Unity 300 spectrometer relative to tetramethylsilane as the internal standard in chloroform-d. Elemental analyses were carried out on a varioEL element analyzer at Toray Research Center, Japan. Thermal transition behavior was determined using a Seiko DSC-6200 differential scanning calorimeter (DSC) at a heating rate of 10° C./min. Thermal degradation temperatures were measured by a Shimadzu TG-40G thermogravimetric analyzer (TGA) at a heating rate of 10° C./min in the air at Toray Research Center (Shiga, Japan).

### EXAMPLE 3

### Example of Synthesis

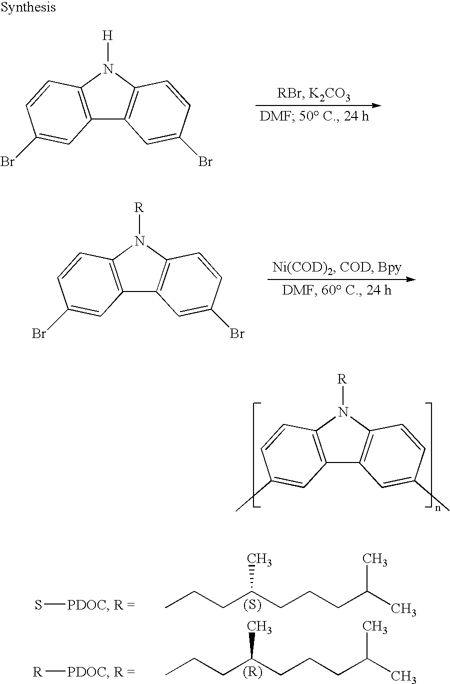

### EXAMPLE 4

### Synthesis of Monomer

The mixture of 3,6-dibromocarbazole (10 mmol), (S)- or (R)-3,7-dimethyloctyl bromide (11 mmol) and potassium carbonate (30 mol) in anhydrous DMF (20 mL) was heated at 50° C. for 24 h under argon, and then 200 mL of water was added. Dichloromethane (3×50 mL) was used to extract the product. The organic layer was washed with water (2×100 mL) and dried over anhydrous magnesium sulfate. The solvent was removed to give the raw product, which was purified by column chromatography using hexane as the eluent to give a colorless viscous liquid. The structures were characterized by ¹H, ¹³C NMR spectroscopies, and elemental analyses.

N—(S)-3,7-dimethyloctyl-3,6-dibromocarbazole Yield 81%. ¹H NMR (CDCl₃, δ ppm): 0.84 (d, J=6.6 Hz, 6H), 0.98 (d, J=6.3 Hz, 3H), 1.06-1.85 (m, 10H), 4.05-4.22 (m, 2H), 7.17 (d, J=8.7 Hz, 2H), 7.50 (dd, J=8.7 Hz, J=1.8 Hz, 2H), 8.05 (d, J=1.8 Hz, 2H). ¹³C NMR (CDCl₃, δ ppm): 19.67, 22.56, 22.64, 24.56, 27.90, 30.77, 35.37, 36.97, 39.12, 41.34, 110.15, 111.84, 123.17, 123.36, 128.90, 139.00. Elemental analysis: Calcd. for C₂₂H₂₇Br₂N: C 56.79, H 5.85, N 3.01, Br 34.35; Found: C, 56.81; H, 5.83; N, 2.93, Br 33.84.

N—(R)-3,7-Dimethyloctyl-3,6-dibromocarbazole Yield 92%. ¹H NMR (CDCl₃, δppm): 0.84 (d, J=6.6 Hz, 6H), 0.97 (d, J=6.3 Hz, 3H), 1.09-1.80 (m, 10H), 4.02-4.20 (m, 2H), 7.15 (d, J=8.7 Hz, 2H), 7.48 (dd, J=8.7 Hz, J=1.8 Hz, 2H), 8.02 (d, J=1.8 Hz, 2H). ¹³C NMR (CDCl₃, δ ppm): 19.65, 22.56, 22.64, 24.55, 27.89, 30.76, 35.35, 36.96, 39.11, 41.31, 110.12, 111.82, 123.13, 123.33, 128.87, 138.97. Elemental analysis: Calcd. for C₂₂H₂₇Br₂N: C 56.79, H 5.85, N 3.01, Br 34.35; Found: C 56.81; H 5.82; N 2.93, Br 33.94.

### EXAMPLE 5

### Synthesis of Polymer

Ni(COD)₂ (12 mmol), COD (10 mmol), and Bpy (12 mmol) were dissolved in 100 mL of anhydrous DMF under argon. The solution was heated at 60° C. for 0.5 h, and then slowly added to the solution of the carbazole monomer (10 mmol) in 20 mL of anhydrous DMF slowly. The reaction was maintained at 60° C. for 24 h, in the dark. The resulting mixture was poured into 1 L of methanol with magnetic stirring. A grey solid was collected by reduced pressure filtration, and then dried under vacuum overnight at room temperature. The raw product was dissolved in THF (200 mL). Undissolved particles were removed by filtration through a membrane filter with the pore size of 0.5 μm to give a transparent yellow solution. After the addition of isopropanol (100 mL), a white solid was precipitated, which was separated by centrifugation and dried under vacuum overnight at room temperature to give the pure product.

Poly(N—(S)-3,7-dimethyloctyl-3,6-carbazole) (S-PDOC) Yield 65%. ¹H NMR (CDCl₃, δ ppm): 0.82 (d, J=6.9 Hz, 6H), 1.00 (d. J=6.3 Hz, 3H), 1.20-2.00 (m, br, 10H), 4.20 (s, br, 2H), 7.42 (d, br, 2H), 7.86 (d, br, 2H), 8.52 (s, br, 2H). ¹³C NMR (CDCl₃, δ ppm): 19.75, 22.60, 22.68, 24.63, 27.94, 30.90, 35.62, 37.10, 39.22, 41.26, 108.84, 118.94, 123.72, 125.42, 133.23, 139.77. Elemental analysis (%) Calcd. for C₂₂H₂₇N: C, 86.51; H, 8.91; N, 4.59; Found: C, 86.37; H, 9.03; N, 4.48.

Poly(N—(R)-3,7-dimetyloctyl-3,6-carbazole) (R-PDOC) Yield 69%. ¹H NMR (CDCl₃, δ ppm): 0.82 (d, J=6.9 Hz, 6H), 1.00 (d, J=6.3 Hz, 3H), 1.20-2.00 (m, br, 10H), 4.20 (s, br, 2H), 7.42 (d, br, 2H), 7.87 (d, br, 2H), 8.52 (s, br, 2H). ¹³C NMR (CDCl₃, δ ppm): 19.75, 22.61, 22.69. 24.63, 27.94, 30.90, 35.63, 37.10, 39.22, 41.28, 108.83, 118.93, 123.72, 125.40, 133.23, 139.77. Elemental analysis (%) Calcd. for C₂₂H₂₇N: C 86.51; H 8.91; N 4.59; Found: C 86.31; H 9.05, N 4.38.

### EXAMPLE 6

### Preparation of the Polymer with Different Molecular Weights (S-PDOT)

Process A.

Ni(COD)₂, COD, and Bpy were mixed in anhydrous DMF under argon. The solution was heated at 60° C. for 0.5 h, and then the carbazole monomer in anhydrous DMF was added. The reaction was maintained at 60° C. for 24 h in the dark. The resulting mixture was poured into methanol (MeOH) with magnetic stirring. A gray colored solid was collected by reduced pressure filtration, and then dried under vacuum overnight at room temperature. The raw product was dissolved in THF. Undissolved particles were removed by filtration through a membrane filter with the pore size of 0.5 μm to give a transparent yellow solution. P1 and P2 were obtained after removing the solvent and dried under vacuum at room temperature overnight. For P3 and P4, after the addition of MeOH, a white solid was precipitated, which was separated by filtration and dried under vacuum overnight at room temperature to give the pure product.

Process B. Ni(COD)₃, COD, and Bay were dissolved in anhydrous DMF under argon. The solution was heated at 60° C. for 0.5 h, and then slowly added to the solution of the carbazole monomer in 20 mL of anhydrous DMF slowly. The reaction was maintained at 60° C. for 24 h in the dark. The resulting mixture was poured into MeOH with magnetic stirring. A gray solid was collected by reduced pressure filtration, and then dried under vacuum overnight at room temperature. The raw product was dissolved in THF. Undissolved particles were removed by filtration through a membrane filter with the pore size of 0.5 μm to give a transparent yellow solution. After the addition of isopropanol (i-PrOH), ethanol (EtOH), or MeOH, a white solid was precipitated, which was separated by centrifugation and dried under vacuum overnight at room temperature to give the pure product.

TABLE 1
Preparation of different molecular weight samples

| | | | | | Ratio (mono- | Solvent for | Yields |
|---|---|---|---|---|---|---|---|
| Products | M_{w} | Mₙ | M_{w}/Mₙ | Process | mer:Ni (0)) | purification | (%) |
| Repeating Unit | 305.46 | — | — | — | — | — | — |
| P1 | 961 | 623 | 1.54 | A | 1:0.5 | MeOH | 95 |
| P2 | 1324 | 1051 | 1.25 | A | 1:0.8 | MeOH | 92 |
| P3 | 1895 | 1392 | 1.36 | A | 1:1.0 | THF:MeOH | 87 |
| P4 | 4001 | 1873 | 2.13 | A | 1:1.2 | THF:MeOH | 83 |
| P5 | 7415 | 4862 | 1.52 | B | 1:0.5 | THF:MeOH | 81 |
| P6 | 12627 | 10430 | 1.21 | B | 1:0.8 | THF:MeOH | 74 |
| P7 | 23350 | 18095 | 1.29 | B | 1:1.0 | THF:EtOH | 70 |
| P8 | 70626 | 29552 | 2.38 | B | 1:1.2 | THF:EtOH | 65 |
| P9 | 108363 | 62073 | 1.74 | B | 1:1.2 | THF:i-PrOH | 8* |

*Fractionation of P8

What is claimed is:

1. A polycarbazole compound comprising units of carbazole having an optically active hydrocarbon group on the ring nitrogen atom, said units being connected each other at the 3- and 6-positions.

2. The polycarbazole compound according to claim 1, which is representable by the formula: 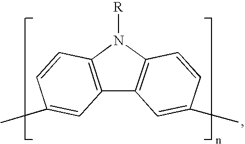
wherein R is an optically active hydrocarbon group and n is an integer of from 5 to 100,000.

3. The polycarbazole compound according to claim 1 or 2, wherein the hydrocarbon group has not less than 5.

4. The polycarbazole compound according to any of claims 1 to 3, wherein the hydrocarbon group has not more than 100.

5. A process for preparing a polycarbazole compound having an optically active hydrocarbon group on the ring nitrogen atom, said units being connected each other at the 3- and 6-positions, which comprises polymerizing a carbazole compound having an optically active hydrocarbon group on the ring nitrogen atom and halogen atoms at the 3- and 6-positions in the presence of a polymerization catalyst.

6. The process according to claim 5, wherein the carbazole compound is representable by the formula: 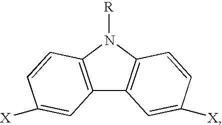
wherein R is an optically active hydrocarbon group and X is a halogen atom.

7. The process according to claim 5 or 6, wherein the hydrocarbon group has not less than 5.

8. The process according to any of claims 5 to 7, wherein the hydrocarbon group has not more than 100.

9. The process according to any of claims 5 to 8, wherein the polymerization catalyst is chosen from zero valent nickel, zero valent zinc, metallic magnesium and organic magensium compounds.

10. The process according to claim 9, wherein the polymerization catalyst is bis(1,5-cyclooctadiene) nickel.

11. The process according to any of claims 5 to 10, wherein the polymerization is carried out at a temperature of from 30 to 100° C.

12. The process according to any of claims 5 to 11, wherein the polymerization is carried out in a liquid medium.

13. A thin film made of the compound according to any of claims 1 to 4.

14. The thin film according to claim 13, which has a thickness of 10 to 500 nm.
